(19) United States
(12) Patent Application Publication
(10) Pub. No.: US 2014/0164562 A1
(43) Pub. Date: Jun. 12, 2014

(54) FORMING COMPUTER SYSTEM NETWORKS BASED ON ACOUSTIC SIGNALS

(71) Applicant: Apple, Inc., Cupertino, CA (US)

(72) Inventors: Brian M. King, Palo Alto, CA (US); David T. Amm, Palo Alto, CA (US); Michael A. Cretella, Palo Alto, CA (US); Omar S. Leung, Cupertino, CA (US)

(21) Appl. No.: 14/077,465

(22) Filed: Nov. 12, 2013

Related U.S. Application Data
(60) Provisional application No. 61/735,232, filed on Dec. 10, 2012.

(51) Int. Cl. H04W 76/02

(52) U.S. Cl. CPC H04W 76/02
USPC 709/217; 709/223; 709/225

(57) ABSTRACT

Described herein are computer-implemented methods, computer-readable media, and computer systems for the establishment of data communications between devices based through the use of acoustic signals. A first device transmits an acoustic signal, which is received by one or more other devices. The first device and the receiving devices establish a new communications network (e.g., create a new Wi-Fi network and/or peer-to-peer wireless network), or form/establish a grouping within a pre-existing communications network to which the devices are all connected. The devices can then exchange data over the new communications network or within the grouping on the pre-existing network. Also described herein are techniques for a device to determine its distance and/or other positioning information relative to another device, using acoustic and/or RF signaling.

### TECHNICAL FIELD

The subject matter described herein generally relates to networks of computer systems.

### BACKGROUND

Computer systems, for example, desktop computers, laptop computers, smart phones, tablet computers, personal digital assistants, and the like, can be connected to each other through one or more wired or wireless networks. To create such a network, multiple computer systems can be hard-wired to each other, for example, through network switches. Alternatively, or in addition, the multiple computer systems can be wirelessly connected to each other, for example, by one or more wireless access points that connect to one or more routers using radio frequency (RF) wireless network protocols such as Wi-Fi, Bluetooth, and the like. When multiple computer systems are within a range of wireless service provided by a wireless network, each of the multiple computer systems can connect to the network. In such situations, data transmitted from a particular computer system can be received by each of the other computer systems. A user of the particular computer system may want to restrict computer systems within the range of the wireless network that can receive the data transmitted from the particular computer system.

### SUMMARY

This specification describes, inter alia, technologies relating to forming computer system networks based on acoustic signals.

In general, one innovative aspect of the subject matter described here can be implemented as a computer-implemented method performed by data processing apparatus. An acoustic signal is generated by a device included in a set of computer systems. Each computer system is connected to a first data communications network. The acoustic signal is transmitted by the device. At least one computer system included in a subset of the set of computer systems is configured to receive the acoustic signal. A second network is formed between the device and the at least one computer system included in the subset.

This, and other aspects, can include one or more of the following features. An item of data can be transmitted by a device to a first computer system in the second network over the data communications network. An item of data can be received from a first computer system in the subset and can be transmitted to a second computer system in the subset. A first computer system in the subset can be configured to transmit an item of data directly to a second computer system in the subset over the data communications network. The device can include an acoustic signal generator configured to generate the acoustic signal. The device can be a computer system or a peripheral device. A response to transmitting the acoustic signal can be received at the device from one or more computer systems in the set. Each of the one or more computer systems in the set can be configured to receive the acoustic signal and provide the response. The second network between the device and each of the one or more computer systems in the set can be formed. Multiple instructions can be encoded in the acoustic signal. The multiple instructions can be executable by a computer system to perform operations including: retrieving a list of computer systems that are authorized to receive the acoustic signal; determining that a computer system is included in the list; and, in response to determining that the computer system is included in the list, designating the computer system as an authorized computer system and including the designated computer system in the second network. Generating the acoustic signal can further include generating multiple keys. Transmitting the acoustic signal can include transmitting the multiple keys with the acoustic signal. Forming the second network can include including each computer system in the set that receives a key of the multiple keys. The second network can be formed at a first time instant. The second network can be terminated based on another acoustic signal transmitted by the device at a second time instant after the first time instant. A distance between the device and the at least one computer system included in the subset can be determined based on the acoustic signal. Determining the distance include transmitting a radio frequency signal at the same time as the acoustic signal, and determining the distance based on a difference in a first time at which the at least one computer system receives the radio frequency signal and a second time at which the at least one computer system receives the acoustic signal. A physical position of the at least one computer system included in the subset can be determined based on the acoustic signal. The computer systems in the set from which a response to transmitting the acoustic signal is not received can be excluded from the second network. The first data communications network can be either a wired network or a wireless network. The first data communications network can be either a Wi-Fi network or a Bluetooth network. The acoustic signal can be in an ultrasonic frequency spectrum. The device can be positioned relative to the at least one computer system in the subset to directly transmit the acoustic signal to the at least one computer system.

Another innovative aspect of the subject matter described here can be implemented as a computer-readable medium storing computer program instructions executable by one or more data processing apparatus to perform operations described here. A further innovative aspect of the subject matter described here can be implemented as a system that includes one or more data processing apparatus, and a computer-readable medium storing computer program instructions executable by the one or more data processing apparatus to perform the operations described here.

The above summary is provided merely for purposes of summarizing some example embodiments so as to provide a basic understanding of some aspects of the subject matter described herein. Accordingly, it will be appreciated that the above-described embodiments are merely examples and should not be construed to narrow the scope or spirit of the subject matter described herein in any way. Other features, aspects, and advantages of the subject matter described herein will become apparent from the following description, drawings, and claims.

### BRIEF DESCRIPTION OF THE DRAWINGS

FIG. 1 illustrates a network of computer systems that includes a subset of computer systems grouped based on acoustic signals.

FIG. 2 illustrates multiple subsets of computer systems in a network grouped based on respective acoustic signals.

FIG. 3 illustrates subsets of computer systems grouped based on a range and directionality of the acoustic signals.

FIG. 4 is a flowchart of an example process for forming a subset of computer systems based on acoustic signals.

FIG. 5 is a block diagram illustrating architecture of a device capable of receiving and generating acoustic signals to form a subset of computer systems.

Like reference numbers and designations in the various drawings indicate like elements.

### DETAILED DESCRIPTION

Multiple computer systems that form a group can communicate with each other and exchange data over RF-based networks, for example, Wi-Fi, Bluetooth, and/or other types of networks. In some situations, a first computer system of the multiple computer systems can form a group with a second computer system. To do so, for example, the first computer system can identify the second computer system and transmit a request to the second computer system to join the group. The second computer system can receive the request and agree; in this manner, the group can be formed. Once the group has been formed, the two computer systems can exchange communications and data with each other over the RF-based networks. In some instances, the two computer systems may also specifically exclude other computing systems from the group; to exclude the remaining computer systems, the first computer system may need to explicitly select and/or identify the remaining computer systems that will be excluded.

This specification describes forming a group of computer systems from among multiple computer systems based on acoustic signals. The forming of the group may be initiated when an acoustic signal is transmitted from one of the computer systems to another computer system. In some instances, the group may be characterized is as an improvised group of computer systems formed for a “casual” use in which multiple computer systems in the group that are connected using an acoustic signal. Once the group is formed, the multiple computer systems communicate and exchange data with each other over wired or wireless networks. By implementing the techniques described herein, the a subset of the multiple computer systems, which includes fewer than all of the multiple computer systems, can may be grouped based on acoustic signals that are audible only to the computer systems within a given range. In other words, other computer systems that are not able to receive the acoustic signals may not be able to join the group.

In some implementations, one of the computer systems can initiate a formation of the group by transmitting an acoustic signal that is audible only to the other computer systems within a given range or distance and/or within a certain room or other division of space. For example, the computer system that initiates the formation of the group can transmit an ultrasonic signal over a range specified by the computer system. Each of the computer systems that are within the range and to which the acoustic signal is audible can automatically be included in the group. Alternatively, or in addition, a computer system to which the acoustic signal is audible can acknowledge a receipt of the acoustic signal and be included in the group. For example, the computer system that initiates the formation can transmit a chirp, and the computer systems to which the chirp is audible can respond with respective chirps and identifiers. In some situations, the acoustic signal can include a randomly generated tone, which can be received by other computer systems that are within the range of the signal. Once validated, the tone can be used as a seed to generate wireless networking security keys and/or other information which could then enable setting up the group and/or communicating within the group. A computer system that was unable to receive the acoustic signal can be excluded from the group.

In some implementations, the computer systems in the group can learn their relative distances from each other by a time of flight of acoustic waves, which can be determined as described below. Subsequently, the computer systems in the group can use the wired or wireless networks to communicate with each other and to exchange data. Additional features of the acoustic signal based on which the group of computer systems is formed are described below.

Implementations of the subject matter described herein can provide one or more of the following potential advantages. A user of a computer system included in a network can form a group that includes one or more other users of respective other computer systems by transmitting an acoustic signal that is audible only to those one or more other users. The users in the group can then use the network that connects all users to communicate and exchange data to the exclusion of users not in the subset. For example, a floor in a building can offer wireless network services to all users who bring a computer system on the floor. The floor can have multiple rooms in which three users meet. One of the three users can transmit an acoustic signal that is audible to the other two users in the room, but is terminated by the walls of the room. In this manner, the three users can form a subset of all users on the floor, and subsequently exchange communications and data, such as, documents, files, video, and the like, only with each other. After the meeting, the transmission of the acoustic signal can be stopped, thereby terminating the grouping. The subject matter can similarly be implemented in crowded enclosures (for example, cafes, conference rooms, and the like) to form subsets of nearby users who can wirelessly communicate and exchange data using while excluding other users in the place.

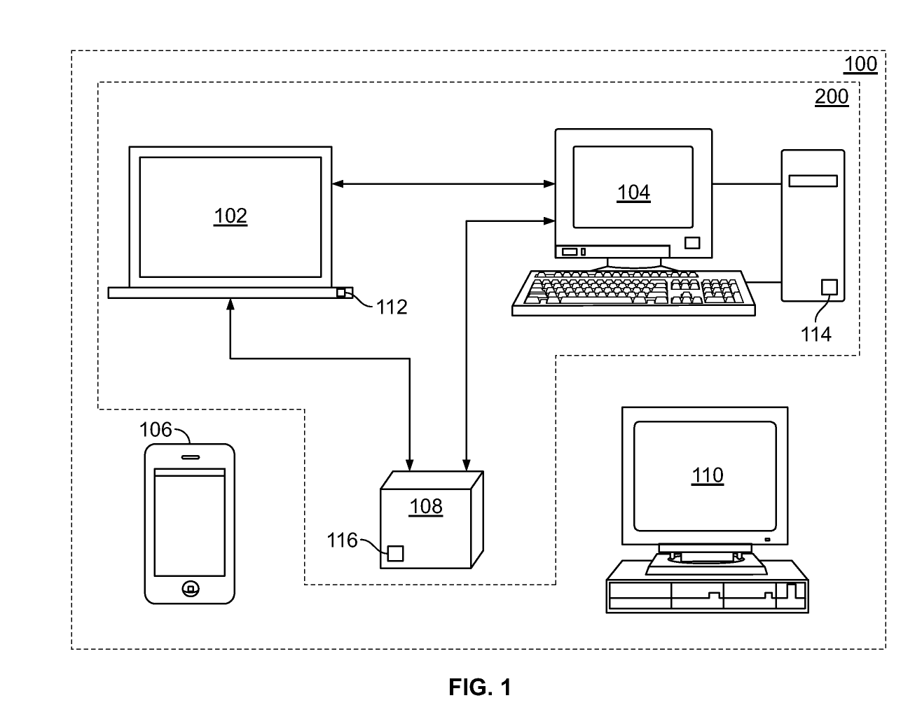

FIG. 1 illustrates a network 100 of computer systems that includes a subset 200 of computer systems grouped based on acoustic signals. The network 100 includes multiple computer systems—for example, a first computer system 102, a second computer system 104, a third computer system 106, a fourth computer system 108, and a fifth computer system 110. A computer system can be a desktop computer, a laptop computer, a tablet computer, a smart phone, a personal digital assistant, and the like. Each computer system can include a respective computer-readable medium storing computer program instructions and respective data processing apparatus configured to execute the instructions to perform operations. In addition, each computer system can implement hardware, software, firmware, or combinations of them, to exchange communications and data from other computer systems, other devices (for example, network switches, routers, and the like), or both. Further, each computer system can include a respective input device—for example, a keyboard, a touch screen, a mouse, a microphone, and the like—using which a user of a computer system can provide input to perform operations. Each computer system can additionally include a respective output device—for example, a monitor, a display area, a speaker, and the like—that can present an output of the operations specified in the input. Each computer system in the network 100 receives wired or wireless data communication services that allow the systems to communicate with each other.

Some of the computer systems in the network 100 can include devices that can generate and receive acoustic signals. For example, the first computer system 102, the second computer system 104, and the fourth computer system can include a first device 112, a second device 114, and a third device 116, respectively, that can each generate and transmit the acoustic signal or receive an acoustic signal generated and transmitted by another device, or both. In some implementations, a device that can generate and transmit the acoustic signal can be any acoustic signal generator such as a speaker, for example, a speaker of a laptop computer or a speaker of a smart phone, or may be a dedicated acoustic signal generator component. A device that can receive the acoustic signal can include a microphone (i.e., the microphone in the device used in the device for receiving audible-range audio data), or may be a dedicated acoustic signal receiver device. In alternative implementations, the source of the acoustic signal can be external to the computer systems. For example, a user can generate a characteristic acoustic signal by clapping hands, using voice commands, or mechanical methods. The devices can be integrated with the hardware, software, or firmware, or combinations of them, of the respective computer system. Alternatively, the devices can be independent of and capable of being connected to the respective computer system. For example, in response to receiving an input from a user of the computer system, the device can generate and transmit the acoustic signal. Similarly, upon receiving an acoustic signal, the device can transmit an output to cause a notification to be provided to the user of the system. For example, the device can transmit a signal to the data processing apparatus of the computer system, in response to which the data processing apparatus can execute operations to display a pop-up user interface in a display device of the computer system.

A frequency and bandwidth of the acoustic signal can be either in the audible range (for example, less than 18 kHz), in the inaudible range (for example, between 18 kHz and 20 kHz), or in the ultrasonic range (for example, greater than 20 kHz). In some implementations, the devices that can generate and receive the acoustic signals can communicate up to 19 kHz, which is in the inaudible range. Alternatively or additionally, the devices that can generate and receive the acoustic signals may communicate in the 20 kHz to 22 kHz range. Hearing capability varies from person to person and degrades with a person's age. It is possible to send acoustic signals over standard audio electronic circuits (for example, at 19 kHz) that would be inaudible to most people. Frequencies higher than standard audio are generally referred to as ultrasonic.

If the acoustic signal is in the audible range, then a volume of the signal can be so low as to be effectively inaudible to most people. As described above, in some implementations, the acoustic signal can include a randomly generated tone, which can be received by other computer systems that are within the range of the signal. Once validated, the tone can be used as a seed to generate wireless networking security keys which could then enable setting up a network that includes only the computer systems in the subset. In some implementations, the acoustic signal can be filtered to clear ambient interferences, noise, and the like. A feature of an acoustic signal is the intuitive expectation of privacy due to either proximity or enclosure. This reduces the need for explicit authentications to join the network or invitations to users outside the region of interest.

In some implementations, the first device 112 can generate and transmit an acoustic signal. For example, a user of the first computer system 102 can provide input to generate an acoustic signal. The input can include a selection of a key on a keyboard or an object displayed in a user interface using either a touch screen or a position indicator, such as a mouse or stylus, or a vocal input into a microphone, or the like. The data processing apparatus of the system 102 can receive the input and execute operations to cause the first device 112 (for example, a speaker) to generate and transmit the acoustic signal. In some implementations, the first device 112 can be configured to transmit the acoustic signal over a range (for example, a distance in meters or feet) that can be varied based on input from the user of the first computer system 102.

Each of the second device 114 and the third device 116 included in the second computer system 104 and the fourth computer system 108 can be within a range (for example, an earshot) of the acoustic signal. Each device can receive the acoustic signal and detect that the signal has been transmitted by the first device 112. The second device 114 may or may not record a sample of the signal. Instead, the second device 114 can obtain an acoustic signature of the acoustic signal, for example, based on time snippets, frequency spaces, and the like. The second device 114 and the third device 116 can transmit respective signals in response to receiving the acoustic signal from the first device 112. In this manner, a subset 200 of computer systems included in the network 100 can be formed.

The computer systems included in the subset 200 can then exchange communications and data between each other using the data communication services available to all computer systems in the network 100. However, because only the computer systems in the subset 200 receive the acoustic signal, the computer systems not in the subset 200 can be excluded from receiving or transmitting data exchanged by the computer systems in the subset 200. In some implementations, the remaining computer systems in the network 100 may not include devices that can receive acoustic signals. In implementations in which the remaining computer systems include devices that can receive acoustic signals, the first device 112 can generate the acoustic signal that can only be detected by the second device 114 and the third device 116, but not by the devices in the remaining computer systems.

As a variation on the features described above, instead of defining a group of computer systems that are already connected to a given network, the features described above may be used, mutatis mutandis, to establish a new communications network. For example: Given devices that are not currently in communication with each other, the devices may communicate using acoustic signals as described above to determine the presence of one another and/or exchange networking security keys and/or other information. Then, the devices may establish a wireless local area network and communicate with each other via the wireless local area network. The wireless local area network may be, for example, a Wi-Fi infrastructure network (where one of the devices acts as an access point (AP)), a Bluetooth network, and/or may be based on a peer-to-peer wireless local area networking technology such as ad hoc Wi-Fi, Apple Wireless Direct Link (AWDL), and/or or Wi-Fi Direct technology. The establishment of the may be performed in a number of different ways, dependent upon the particular implementation. For example: In a Wi-Fi scenario, the information exchanged by the devices in acoustic signals may include information such as a service set identifier (SSID) for the network that will be formed and/or a security keys for joining the network (for security schemes such as Wired Equivalent Privacy (WEP) or Wi-Fi Protected Access (WPA)). In a Bluetooth scenario, the information exchanged by the devices in acoustic signals may be, for example, the information required to pair according the Bluetooth legacy pairing or Secure Simple Pairing (SSP) schemes. Analogous/corresponding information may be communicated in the acoustic signals when other communications technologies are used.

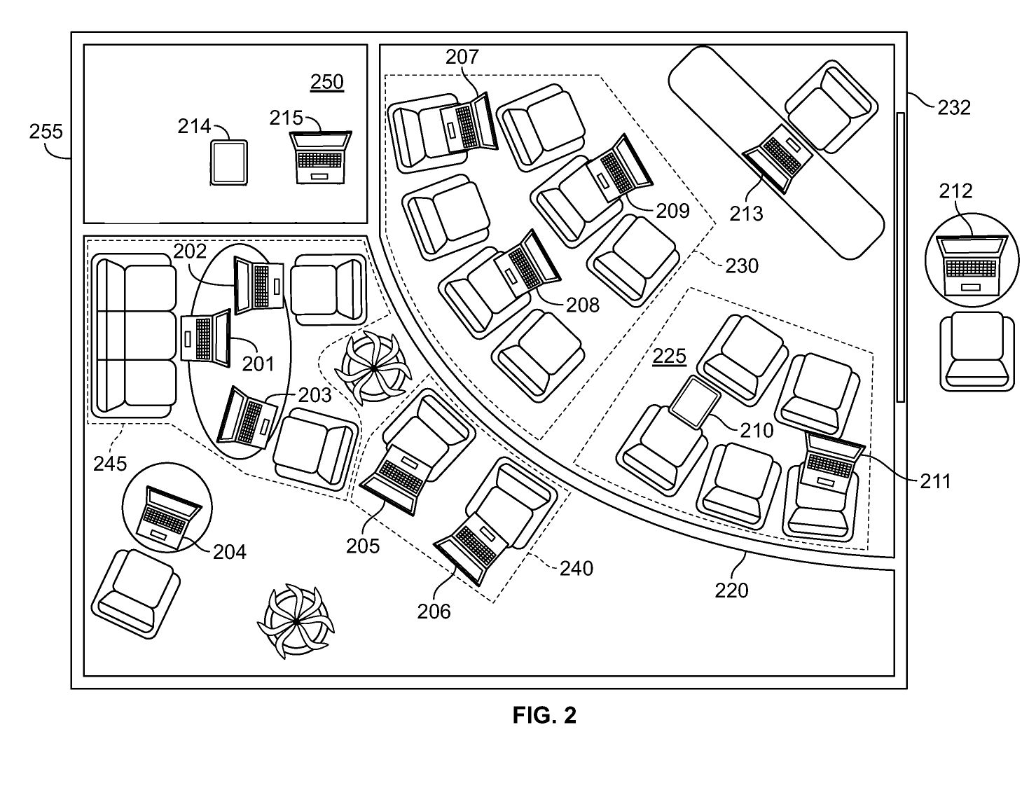

FIG. 2 illustrates multiple subsets of computer systems in a network grouped based on respective acoustic signals. FIG. 2 shows multiple computer systems (for example, computer systems 201-215) that are within a range of a wired or a wireless network, for example, a Wi-Fi network, and configured to communicate with each other over the network. But for the twelfth computer system 212, all the computer systems are within an enclosure bound by a right wall 232 and a left wall 255. The computer systems within the enclosure are further separated by a third wall 220. Within the enclosure, five subsets of computer systems are formed based on acoustic signals as described below. The computer systems in each subset can be connected to each other to communicate and to exchange data using respective acoustic signals generated and transmitted by one of the computer systems in each subset as described below. Alternatively, or in addition, the acoustic signal can be generated and transmitted by a source other than any computer system in each subset.

A first subset 245 of computer systems includes the first computer system 201, the second computer system 202, and the third computer system 203. For example, the first computer system 201 generates and transmits an acoustic signal by implementing the techniques described above. The acoustic signal identifies a spatial relationship between the three computer systems in the first subset 245. The spatial relationship can be a simple binary indicator, for example, the computer systems 202 and 203 can hear the acoustic signal transmitted by the first computer system 201 whereas the remaining computer systems cannot. The walls within the enclosure prevent the acoustic signal generated by the first computer system 201 from traveling through, thereby allowing creation of an ad-hoc subset of computer systems based on each computer system in the subset being within earshot of each other. The computer systems 201, 201, and 203 in the first subset 245 can then communicate and exchange data with each other over the wired or wireless network that connects all fifteen computer systems, but by excluding the remaining computer systems. Such a subset can be implemented to conduct collaborative meetings between users of the computer systems in the first subset 245 without requiring pre-arranged network infrastructures.

A second subset 240 that includes the fifth computer system 205 and the sixth computer system 206 can be implemented similarly to the first subset 245. Each of the first subset 245 and the second subset 240 can exclude the fourth computer system 204, for example, because the fourth computer system 204 is outside an earshot of the acoustic signal in each of the first subset 245 and the second subset 240.

FIG. 2 additionally illustrates a third subset 230 that includes the seventh computer system 207, the eighth computer system 208, and the ninth computer system 209. To form the third subset 230, the ninth computer system 209 can transmit an acoustic signal, which can be terminated by the third wall 220 and the right wall 232. Further, the acoustic signal can have a range that encompasses the locations of the seventh, and eighth computer systems 207 and 208, and additionally those of the tenth, eleventh, and thirteenth computer systems 210, 211, and 213. One or more or all of the computer systems that receive the acoustic signal can transmit a response to the acoustic signal, which the ninth computer system 209 can receive. Each computer system that transmits a respective response can include a corresponding identifier in the response. The ninth computer system 209 can store, for example, on a computer-readable storage medium, a list that includes identifiers of multiple computer systems. The ninth computer system 209 can scan the list of identifiers to identify the computer systems from which responses to the acoustic signal are received. From the list, the ninth computer system 209 can select the seventh computer system 207 and the eighth computer system 208 to form the third subset 207. In some implementations, the ninth computer system 209 can display the list of identifiers in a display device to allow a user to select the computer systems that the user wants to include in the third subset 230. In this manner, the ninth computer system 209 can restrict the third subset 230 to include only three computer systems although the acoustic signal was within earshot of five computer systems.

The fourth subset 225 that includes the tenth computer system 210 and the eleventh computer system 211 can be implemented similarly to the third subset 230. The fifth subset 250 that includes the fourteenth computer system and the fifteenth computer system can be implemented using any of the techniques described above. In some implementations, the fifteenth computer system 215 can generate an acoustic signal that is within the earshot of the fourteenth computer system 214 and is terminated by the third wall 220 and the left wall 255. The acoustic signal can be encoded, for example, by implementing range-finding SONAR type technology, digital modulation schemes (such as adding 1s and 0s to the signal, frequency shifting, amplitude modulation, implementing ON/OFF keys, and the like), or combinations of them. The fifteenth computer system 215 can receive a response from the fourteenth computer system 214, which the fifteenth computer system 215 can validate. Once validated, the fifteenth computer system can generate and transmit wireless networking security keys to the fourteenth computer system 214 to generate the fifth subset 250. Computer systems that enter the enclosure but that cannot hear the security seed cannot join the fifth subset 250. In this manner, subsets of computer systems can be formed based on acoustic signals by implementing one or more of the techniques described above either alone or in one or more combinations. Only the computer systems in a subset can exchange communications and data including files, media, and the like, with each other.

In some implementations, peripheral devices such as projectors, computer screens, wireless printers, speakers, monitors, and the like, can be configured to receive acoustic signals and to be included in the subsets. For example, users of computer systems can meet in a conference room that includes a projector. The users' computer systems and the projector can be connected to a wireless network that provides data communication service to all computers and devices on a floor in which the conference room is located. The users can form a subset that includes the computer systems and the projector based on an acoustic signal by implementing the techniques described above. The users can then exchange (i.e., transmit and receive) items of data between each other's respective computer systems and the device.

The acoustic signal can be sufficiently robust so that the computer systems and the device remain connected to each other. In some implementations, the computer systems and the device can exchange low rates of digital information over the acoustic signal that links the systems and the device, for example, by implementing a key over the low-bandwidth acoustic network to transmit data at high speed over the higher bandwidth wireless network. Alternatively, or in addition, the acoustic signal can be used for forming and maintaining the ad-hoc subset, and data communication can be handled by the wireless network that can have a greater bandwidth relative to the acoustic signal. The users can then exchange media, data files, and the like, with each other, and can additionally display the media using the projector.

Once the meeting is over, the subset can cease to exist, for example, because a source of the acoustic signal ceases to transmit the acoustic signal. In some implementations, a computer system in the subset can cease to be included in the subset, for example, if the computer system is physically transported outside a range of the acoustic signal. In some implementations, a computer system in the subset can be excluded from the subset, for example, by ceasing to transmit the audio signal to the computer system. In some implementations, the computer systems or the devices that are included in the subset can periodically transmit a pulse, for example, an acoustic pulse, at a pre-determined frequency to indicate a respective presence in the subnet. If a pulse is not received from a computer system or a device for a time period, then the computer system or device is determined to no longer be included in the subset. In some implementations, the subset can be transmitted in response to receiving another acoustic signal from the computer system from which the acoustic signal to form the subset was received.

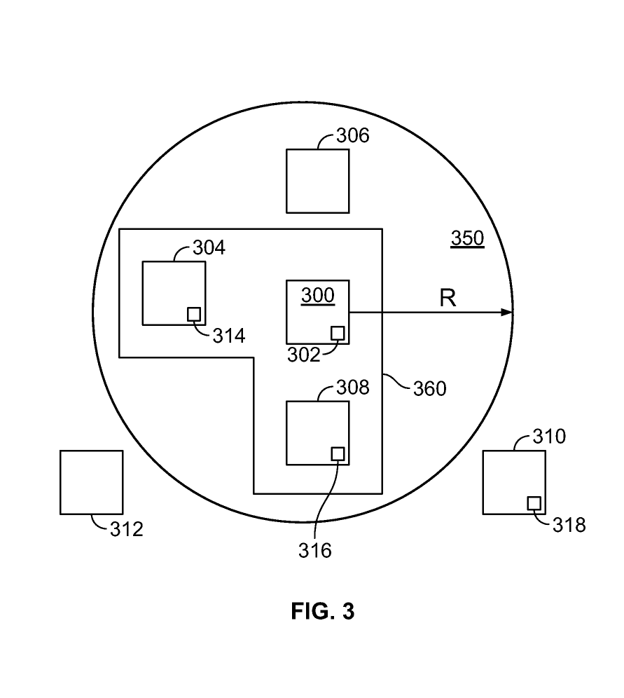

FIG. 3 illustrates subsets of computer systems grouped based on a range and directionality of the acoustic signals. A first computer system 300 includes a first acoustic signal generator 302 that is configured to generate an acoustic signal that has a range having a radius (R). The generator 302 is connected to the system 300; in response to input from the system 300, the radius of the range of the acoustic signal can be tuned. A second computer system 304, a third computer system 306, and a fourth computer system 308 are within the radius of the range, and are included in a subset 350 formed by implementing techniques described above. In some implementations, computer systems that are within a radius of the range of the acoustic signal can nevertheless be excluded from a subset if an enclosure (for example, a wall) interrupts the acoustic signal. The distance between the computer systems in the subset 350 can be determined, in some implementations, based on a time of flight of the acoustic signal generated by the generator 302.

In some implementations, the distance can be determined based on a time taken for a response to the signal to be received. For example, the second computer system 304 can include a transceiver 314 that receives the signal generated by the generator 302 and transmits a response. The generator 302 can be configured to receive the response, based on which the first computer system 300 can determine a distance to the second computer system 304.

In some implementations, the generator 302 can be configured to transmit an RF pulse with a timer simultaneously with the acoustic signal. The generator 302 can encode the RF pulse and the acoustic signal to indicate that both signals were transmitted from the first computer system 300. A third computer system 308 can include a third transceiver 316 that can receive the RF pulse and the acoustic signal. Because the speed of sound and speed light are nearly six orders of magnitude apart, the third transceiver 316 will receive the RF pulse before the acoustic signal. The third transceiver 316 can determine that the RF pulse and the acoustic signal were transmitted by the same device. Based on a difference in time to receive the RF pulse and the acoustic signal, the third transceiver 316 can determine a distance to the first computer system 300.

In response to receiving the RF pulse and the acoustic signal, the third transceiver 316 can transmit a corresponding RF pulse and an acoustic signal, which the first computer system 300 can use to determine a distance to the third computer system 308. In this manner, the computer systems can determine distances from each other. Further, the first computer system 300 can identify computer systems to be included in the subset 350 by specifying a radius of the range of the acoustic signal (for example, in an order of centimeters or millimeters), and by excluding computer systems or devices that are at respective distances that are greater than the radius, for example, the computer system 312 and the computer system 310 that includes a transceiver 318.

In some implementations, the internal clocks of the computer systems can be synchronized, for example, by communicating over a wired or wireless network. The signal propagation time for a wired or a radio communication is lesser than a time to communicate an acoustic signal through air. After clock synchronization, one computer system can communicate a schedule for future ultrasonic transmissions. For example, one computer system can schedule an ultrasonic transmission every 100 ms. A second computer system would expect the start time of the ultrasonic transmission every 100 ms, and would measure a received pulse relative to that pre-scheduled time (using its synchronized clock) and would be able to calculate the ultrasonic time of flight. This time of flight is used, with the speed of ultrasound in air, to calculate distance.

In some implementations, the first computer system 300 can implement techniques to form a subset 360 that includes computer systems that are arranged in a specific spatial arrangement (for example, an L-shape) relative to the first computer system 300. In the example shown in FIG. 3, the subset 360 includes the second computer system 304 and the fourth computer system 308, each including a second transceiver 314 and a fourth transceiver 316, respectively. The first computer system 300 excludes the third computer system 306 from the subset 360 although the radius of the range of the acoustic signal generated by the generator 302 encompasses the third computer system 306. The computer systems in the subset 360 that are based on the specific spatial arrangement can implement one or more microphone arrays to obtain directionality and angle of sound.

In some implementations, the range-finding techniques described above can be implemented with the directionality techniques. For example, if all the computer systems in an enclosure can determine respective distances from each other, then techniques, such as intersecting spheres technique, to determine a three-dimensional (3D) position of the computer systems in the enclosure can be implemented. Alternatively, or in addition, techniques based on angles, distances, geometries, and the like can be used to determine positions of the computer systems. Further, if one or more computer systems in the subset include a digital compass, then an orientation of the subset can be determined. Also, if one or more of the computer systems include a geographic location indicator, for example, a Global Positioning System (GPS) receiver, then a geographic location of the subset can be determined. By implementing directional beam steering or by implementing multiple acoustic signal receivers (for example, ultrasonic receivers) to determine a direction of the arrival of the acoustic signal, a relative orientation of each computer system in the subset can be determined.

As described above with reference to FIGS. 2 and 3, subsets of computer systems can be formed based on one or more of a range of an acoustic signal, an enclosure within which the computer systems in a subset are physically present, a predetermined radius of the acoustic signal determined using time of flight, spatial mapping, or combinations of them. An initiation signal can be used to identify computer systems to include in the subset. A periodic acoustic signal can be used to maintain or terminate inclusion in the subset or both.

The above description of FIG. 2 and FIG. 3 describes features in terms of a subset of computer systems out of a set of computer systems that are all connected to the same pre-existing network. It should be understood that the features described above with reference to FIG. 2 and/or FIG. 3 may also be used, mutatis mutandis, in a context where acoustic signals are used for the creation/establishment of new networks (as described above with reference to FIG. 1).

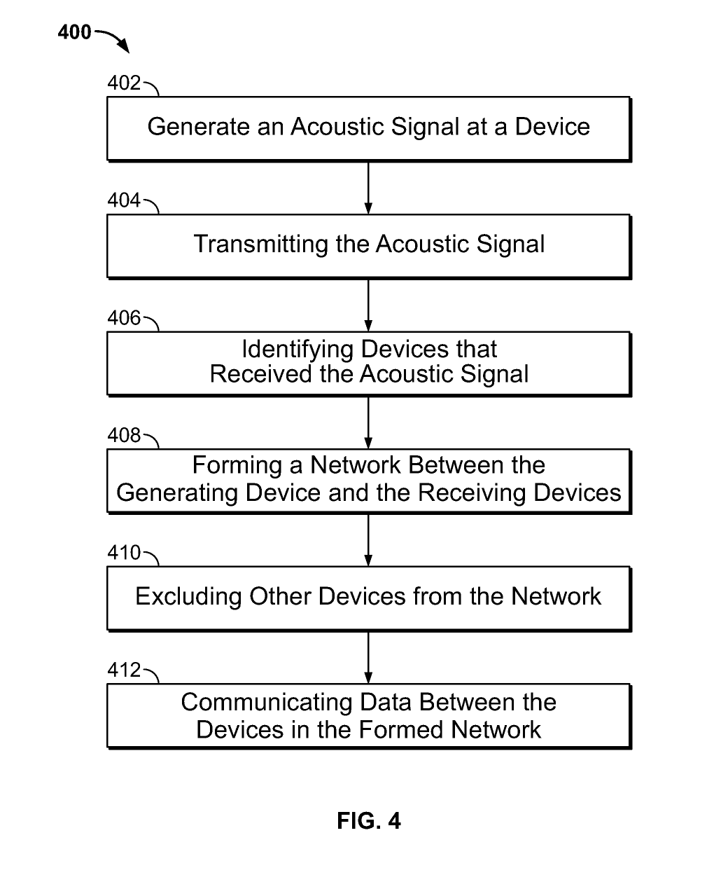

FIG. 4 is a flowchart of an example process 400 for forming a grouping/network of computer systems based on acoustic signals. At 402, an acoustic signal is generated at a device. At 404, the acoustic signal is transmitted. At 406, devices that received the acoustic signal and possibly other criteria are identified. At 408, a grouping or network is formed between the acoustic signal generating device and the acoustic signal receiving devices. Step 408 may include defining a grouping as a subset of computer systems that are already present on a given network (e.g., in an instance where a number of computer systems are connected to a Wi-Fi network that covers an entire floor in a building, this may include identification of the subset of computer systems that received the acoustic signal); alternatively, step 408 may include the creation/formation of a new network (e.g., as described above with reference to FIG. 1, establishing a new Wi-Fi network with an SSID that was communicated during step 404/step 406.) At 410, other devices are excluded from the network. (In some instances, step 410 may not require any affirmative action by any devices. For example, in an instance where a new network is created at step 408, any devices that did not join the new network would by definition not be a part of (i.e., would be excluded from) the new network.) At 412, data is communicated between the devices in the formed group/network.

In this manner, a subset of computer systems that are within a range (for example, an “earshot”) of the acoustic signal can be formed, thereby excluding computer systems that are outside the range. The acoustic signal can be designed to terminate upon contacting physical barriers, thereby automatically restricting computer systems in the subset to those within a physical enclosure such as a room, and excluding those outside the enclosure. Further, a range of the acoustic signal can be tuned to be audible to only those computer systems that are within a spatial proximity of the computer system that transmits the signal, thereby excluding computer systems that may be within the same enclosure but outside the range of the signal. Further a time of flight calculation can be used to specify a specific radius. In addition, a directionality of the acoustic signal can be tuned to include computer systems that are positioned in certain configurations (for example, in an L-shaped configuration) and further excluding other computer systems.

In some implementations, the techniques described here can be implemented to mirror a display of a first display device, for example, a display device of a tablet computer, on another display device, for example, a display device connected to another computer. The techniques can also be implemented to form multiple subnets that share a common user, and to transmit data across multiple subnets.

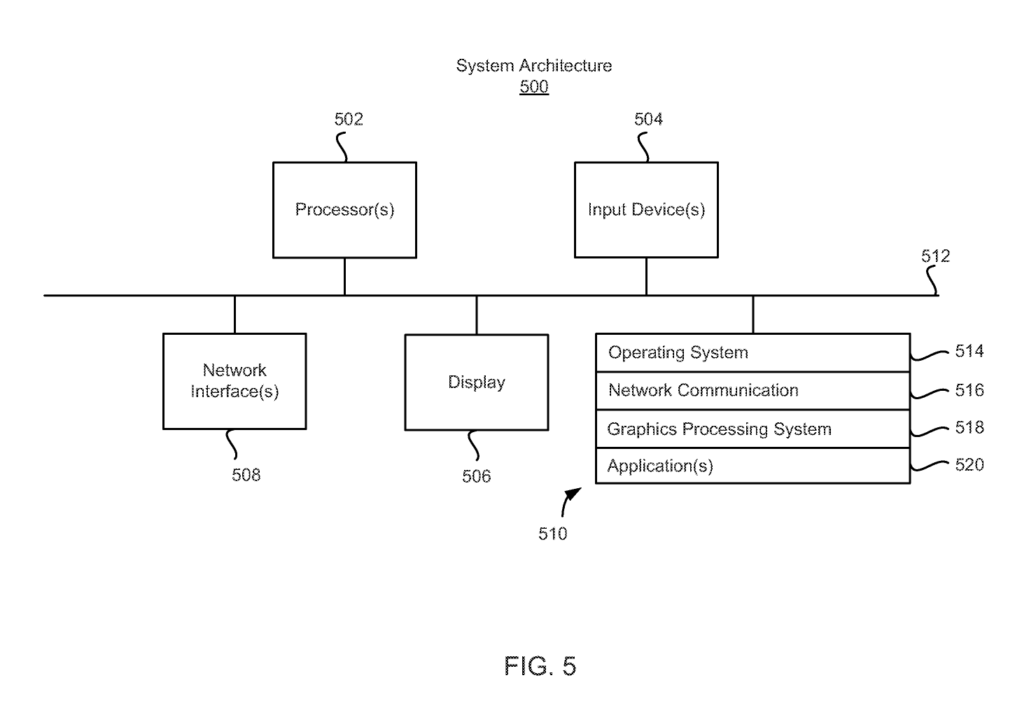

FIG. 5 is a block diagram illustrating architecture of a device capable of receiving and generating acoustic signals to form a subset of computer systems. The architecture 500 can be implemented on any electronic device that runs software applications derived from compiled instructions, including without limitation, personal computers, servers, smart phones, media players, electronic tablets, game consoles, electronic mail (email) devices, and the like. In some implementations, the architecture 500 can include one or more processors 502 (or data processing apparatuses), one or more input devices 504, one or more display devices 506, one or more network interfaces 508, and one or more computer-readable mediums 510. Each of these components can be coupled by bus 512.

Display devices 506 can be any known display technology, including but not limited to display devices using Liquid Crystal Display (LCD) or Light Emitting Diode (LED) technology. Processor(s) 502 can use any known processor technology, and can include but are not limited to graphics processors and multi-core processors. Input device 504 can be any known input device technology, including but not limited to a keyboard (including a virtual keyboard), mouse track ball, touch-sensitive pad or display, microphone (or any device capable of receiving an audio input), and the like. Bus 512 can be any known internal or external bus technology, including but not limited to ISA, EISA, PCI, PCI Express, NuBus, USB, Serial ATA or FireWire. Computer-readable medium 510 can be any medium that participates in providing instructions to processor(s) 502 for execution, including without limitation, non-volatile storage media (for example, optical disks, magnetic disks, flash drives, and the like) or volatile media (for example, SDRAM, ROM, and the like).

The device can include an acoustic signal generator (not depicted in FIG. 5) that is capable of generating acoustic signals such as those described above with reference to, inter alia, FIG. 1 through FIG. 4. The acoustic signal generator can implement techniques such as frequency modulation (FM) synthesis or wave table synthesis to generate and modulate the acoustic signal. The acoustic signal generator can include application program interfaces (APIs) and sound cards to communicate with computer software applications, for example, sound card drivers, implemented in and executed by the device. The acoustic signal generator can be connected to one or more speakers or other components through which the acoustic signal is transmitted. The acoustic signal generator can include a pitch generator, a sweep generator, multipitch generator, tone bursts, or combinations of one or more of them to generate acoustic signals across a range of frequencies. In various implementations, the acoustic signal generator may generate acoustic signals in a number of different frequency ranges, including but not limited to ranges such as: 18 kHz to 19 kHz; 18 kHz to 20 kHz; 18 kHz to 22 kHz; 20 kHz to 22 kHz; any range or combination of ranges between 18 kHz to 22 kHz; and/or any other range or combination of ranges appropriate for implementing the features described herein. Alternatively, or in addition, the device can implement computer software applications to generate the acoustic signal. The acoustic signal generator may be implemented as and/or include a microelectromechanical systems (MEMS) device.

The device can also include an acoustic signal receiver (also not depicted in FIG. 5) that is capable of receiving acoustics signals such as those described above with reference to , inter alia, FIG. 1 through FIG. 4. Alternatively or additionally, the acoustic signal receiver may be capable of receiving acoustic signals communicated by the above-described acoustic signal generator. The acoustic signal receiver may be implemented as and/or include a microelectromechanical systems (MEMS) device. In various implementations, the acoustic signal receiver may be implemented in combination with, connected to, and/or otherwise in conjunction with the above-mentioned microphone in the device; alternatively, the acoustic signal receiver may be implemented within its own separate subsystem within the device, and/or in any other appropriate configuration.

Computer-readable medium 510 can include various instructions 514 for implementing an operating system (for example, Mac OS®, Windows®, Linux, or the like). The operating system can be multi-user, multiprocessing, multitasking, multithreading, real-time, and the like. The operating system performs basic tasks, including but not limited to recognizing input from input device 504; sending output to display device 506; keeping track of files and directories on computer-readable medium 510; controlling peripheral devices (for example, disk drives, printers, projectors, and the like) which can be controlled directly or through an I/O controller; and managing traffic on bus 512. Network communications instructions 516 can establish and maintain network connections (for example, software for implementing communication protocols, such as TCP/IP, HTTP, Ethernet, and the like).

A processing system 518 can include instructions that provide capabilities to form computer networks based on acoustic signals. For example, the processing system 518 can implement process 400 described with reference to FIG. 4. In some implementations, the processing system 518 can generate acoustic signals, for example, in response to receiving an input from one of the input devices.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (for example, Objective-C, Java, and the like), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, implementations of the subject matter described in this specification can be implemented on a computer having a display device, for example, a CRT (cathode ray tube) or LCD (liquid crystal display) monitor, for displaying information to the user and a keyboard and a pointing device, for example, a mouse or a trackball, by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input, for example, a touch on a touch-screen. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. Implementations of the subject matter described in this specification can also be implemented in a cloud computing environment in which information from one or more of the front-end component, the back-end component, the middleware component can be stored in the cloud computing environment.

The computing system can include clients and servers. A client and server are generally remote from each other and typically interact through a communication network. The relationship of client and server arises by virtue of computer programs running on the respective computers and having a client-server relationship to each other. One or more features or steps of the disclosed embodiments can be implemented using an API. An API can define on or more parameters that are passed between a calling application and other software code (e.g., an operating system, library routine, function) that provides a service, that provides data, or that performs an operation or a computation.

The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API. In some implementations, an API call can report to an application the capabilities of a device running the application, such as input capability, output capability, processing capability, power capability, communications capability, and the like.

While this specification contains many specific implementation details, these should not be construed as limitations on the scope of any implementations or of what may be claimed, but rather as descriptions of features specific to particular implementations of particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As mentioned above, the RF-based networks that may be used to implement the features described herein include but are not limited to Wi-Fi and Bluetooth networks. As used herein, the term “Wi-Fi” refers to technology such as but not limited to IEEE 802.11a, 802.11b , 802.11g, 802.11n, 802.11 ac, and/or 802.11 ad. Alternatively or additionally, RF-technologies that may be used to implement the features described herein include Zigbee, Wireless USB, cellular and/or femtocell technologies (such as, for example, GSM/EDGE, CDMA2000, UMTS, LTE, or LTE-A technologies), and/or any other appropriate type of wireless technology.

A number of implementations have been described. Nevertheless, it will be understood that various modifications may be made. For example, other steps may be provided, or steps may be eliminated, from the described flows, and other components may be added to, or removed from, the described systems.

In some implementations, the device can be configured to generate and transmit an acoustic signal in response to receiving voice commands. For example, an identity of multiple computer systems that are within a range of an acoustic signal generated by a particular computer system can displayed in a display device connected to the first computer system. To form the group described above, a user of the particular computer system can provide a voice command to form a group and specify the identities of one or more of the multiple computer systems to be included in the group. In response, the device can generate and transmit the acoustic signal, and form the group that includes the particular computer system and the one or more computer systems whose identities the user specified in the voice command.

What is claimed is:

1. A method performed by data processing apparatus, the method comprising:
generating, by a device, included in a set of computer systems, an acoustic signal, wherein each computer system is connected to a first data communications network;
transmitting, by the device, the acoustic signal, wherein at least one computer system included in a subset of the set of computer systems is configured to receive the acoustic signal; and
forming a second network between the device and the at least one computer system included in the subset.

2. The method of claim 1, further comprising, transmitting, by the device, an item of data to a first computer system in the second network over the data communications network.

3. The method of claim 1, further comprising:
receiving, at the device, an item of data from a first computer system in the subset; and
transmitting, by the device, the item of data to a second computer system in the subset.

4. The method of claim 1, wherein a first computer system in the subset is configured to transmit an item of data directly to a second computer system in the subset over the data communications network.

5. The method of claim 1, wherein the device includes an acoustic signal generator configured to generate the acoustic signal.

6. The method of claim 1, wherein the device is a computer system or a peripheral device.

7. The method of claim 1, further comprising:
receiving, at the device, a response to transmitting the acoustic signal from one or more computer systems in the set, wherein each of the one or more computer systems in the set is configured to receive the acoustic signal and provide the response; and
forming the second network between the device and each of the one or more computer systems in the set.

8. The method of claim 1, further comprising encoding a plurality of instructions in the acoustic signal, the plurality of instructions executable by a computer system to perform operations comprising:
retrieve a list of computer systems that are authorized to receive the acoustic signal;
determine that a computer system is included in the list; and
in response to determining that the computer system is included in the list:
designate the computer system as an authorized computer system, and
include the designated computer system in the second network.

9. The method of claim 1, wherein generating the acoustic signal further comprises generating a plurality of keys, wherein transmitting the acoustic signal comprises transmitting the plurality of keys with the acoustic signal, and wherein forming the second network comprises including, each computer system in the set that receives a key of the plurality of keys.

10. The method of claim 1, wherein the second network is formed at a first time instant, and wherein the method further comprises terminating the second network based on another acoustic signal transmitted by the device at a second time instant after the first time instant.

11. The method of claim 1 further comprising determining a distance between the device and the at least one computer system included in the subset based on the acoustic signal.

12. The method of claim 11, wherein determining the distance comprises:
transmitting a radio frequency signal at the same time as the acoustic signal; and
determining the distance based on a difference in a first time at which the at least one computer system receives the radio frequency signal and a second time at which the at least one computer system receives the acoustic signal.

13. The method of claim 1, further comprising determining a physical position of the at least one computer system included in the subset based on the acoustic signal.

14. The method of claim 1, wherein computer systems in the set from which a response to transmitting the acoustic signal is not received are excluded from the second network.

15. The method of claim 1, wherein the first data communications network is either a wired network or a wireless network.

16. The method of claim 14, wherein the first data communications network is a Wi-Fi network or a Bluetooth network.

17. The method of claim 1, wherein the acoustic signal is in an ultrasonic frequency spectrum.

18. The method of claim 1, wherein the device is positioned relative to the at least one computer system in the subset to directly transmit the acoustic signal to the at least one computer system.

19. A non-transitory computer-readable medium storing instructions executable by one or more data processing apparatus to perform operations comprising:
generating, by a device, included in a set of computer systems, an acoustic signal, wherein each computer system is connected to a first data communications network;
transmitting, by the device, the acoustic signal, wherein at least one computer system included in a subset of the set of computer systems is configured to receive the acoustic signal; and
forming a second network between the device and the at least one computer system included in the subset.

20. The medium of claim 19, the operations further comprising, transmitting, by the device, an item of data to a first computer system in the second network over the data communications network.

21. The medium of claim 19, the operations further comprising:
receiving, at the device, an item of data from a first computer system in the subset; and
transmitting, by the device, the item of data to a second computer system in the subset.

22. The medium of claim 19, wherein a first computer system in the subset is configured to transmit an item of data directly to a second computer system in the subset over the data communications network.

23. The medium of claim 19, wherein the device is a peripheral device that includes an acoustic signal generator configured to generate the acoustic signal.

24. The medium of claim 23, wherein the device is a computer system or a peripheral device.

25. The medium of claim 19, the operations further comprising:
receiving, at the device, a response to transmitting the acoustic signal from one or more computer systems in the set, wherein each of the one or more computer systems in the set is configured to receive the acoustic signal and provide the response; and
forming the second network between the device and each of the one or more computer systems in the set.

26. The medium of claim 19, the operations further comprising encoding a plurality of instructions in the acoustic signal, the plurality of instructions executable by a computer system to perform operations comprising:
retrieve a list of computer systems that are authorized to receive the acoustic signal;
determine that a computer system is included in the list; and
in response to determining that the computer system is included in the list:
designate the computer system as an authorized computer system, and
include the designated computer system in the second network.

27. The medium of claim 19, wherein generating the acoustic signal further comprises generating a plurality of keys, wherein transmitting the acoustic signal comprises transmitting the plurality of keys with the acoustic signal, and wherein forming the second network comprises including, each computer system in the set that receives a key of the plurality of keys.

28. The medium of claim 19, wherein the second network is formed at a first time instant, and wherein the operations further comprise terminating the second network based on another acoustic signal transmitted by the device at a second time instant after the first time instant.

29. The medium of claim 19, the operations further comprising determining a distance between the device and the at least one computer system included in the subset based on the acoustic signal.

30. The medium of claim 28, wherein determining the distance comprises:
transmitting a radio frequency signal at the same time as the acoustic signal; and
determining the distance based on a difference in a first time at which the at least one computer system receives the radio frequency signal and a second time at which the at least one computer system receives the acoustic signal.

31. The medium of claim 19, the operations further comprising determining a physical position of the at least one computer system included in the subset based on the acoustic signal.

32. The medium of claim 19, wherein computer systems in the set from which a response to transmitting the acoustic signal is not received are excluded from the second network.

33. The medium of claim 19, wherein the first data communications network is either a wired network or a wireless network.

34. The medium of claim 33, wherein the first data communications network is either a Wi-fi network or a Bluetooth network.

35. The medium of claim 1, wherein the acoustic signal is in an ultrasonic frequency spectrum.

36. The medium of claim 1, wherein the device is positioned relative to the at least one computer system in the subset to directly transmit the acoustic signal to the at least one computer system.

37. A system comprising:
one or more data processing apparatus; and
a computer-readable medium storing instructions executable by the one or more data processing apparatus to perform operations comprising:
generating, by a device, included in a set of computer systems, an acoustic signal, wherein each computer system is connected to a first data communications network;
transmitting, by the device, the acoustic signal, wherein at least one computer system included in a subset of the set of computer systems is configured to receive the acoustic signal; and
forming a second network between the device and the at least one computer system included in the subset.
